(19) United States
(12) Patent Application Publication
(10) Pub. No.: US 2021/0095534 A1
(43) Pub. Date: Apr. 1, 2021

(54) COILED TUBING APPARATUS FOR OIL AND GAS WELL OPERATIONS

(71) Applicant: TY-CROP MANUFACTURING LTD., Rosedale (CA)

(72) Inventor: Gary Wayne Teichrob, Rosedale (CA)

(21) Appl. No.: 17/019,512

(22) Filed: Sep. 14, 2020

Related U.S. Application Data
(60) Provisional application No. 62/906,418, filed on Sep. 26, 2019.

(51) Int. Cl. E21B 19/22; B65H 75/30

(52) U.S. Cl. CPC E21B 19/22; B60P 3/035; B65H 75/30

(57) ABSTRACT

A coiled tubing reel apparatus for a coiled tubing unit, suitable oil and gas well operations, is provided. A reel is supported at the outside edge of the reel rims, and driven by one or more drives which interface with the reel. The drives are offset from the rotational axis of the reel.

### CROSS-REFERENCE TO RELATED APPLICATIONS

This application claims priority to U.S. Provisional Patent Application No. 62/906,418 entitled COILED TUBING APPARATUS FOR OIL AND GAS WELL OPERATIONS, filed Sep. 26, 2019, the entire contents of which are incorporated herein by reference.

### FIELD OF THE INVENTION

The present invention pertains to the field of oil and gas wells creation and maintenance, and in particular to an apparatus for holding and delivering coiled tubing for use in oil and gas well operations.

### BACKGROUND

In coiled tubing operations, a very long, flexible metal pipe (known as coiled tubing) is pushed downhole into an oil and gas well (wellbore) for a variety of reasons, but primarily for well intervention work. This tubing is typically spooled on a large trailer-mounted reel and trucked to the site. Diameters and lengths of the coiled tubing and reels have increased over time, with a tubing size of 2⅞″ and length of 26,500′ being reported on some current trailers. This size would typically require a 12.5′-14′ wide and 14.5′ tall reel, nearing or exceeding the maximum reasonable limits for a trailer destined for a well site.

Well sites are typically located in remote locations, making oversized loads such as large lengths of coiled tubing expensive to transport. As well, the final leg of the route is often along rough or otherwise difficult to traverse lease roads, further making transportation difficult. The large number of axles and/or boosters and/or jeeps required to support the weight and size of the load are impractical.

Furthermore, wells are being drilled to 30,000′ and beyond, meaning even longer and thicker tubing is needed.

As a result of this demand, it would be beneficial to improve the coiled tubing delivery apparatus in one or more ways, for example by increasing the reel size, improving the package size for road transportation, or decreasing the weight of the unit. It is challenging to do this in such a way that respects practical transport limitations and regulations.

Therefore there is a need for a coiled tubing apparatus that is not subject to one or more limitations of the prior art.

This background information is provided to reveal information believed by the applicant to be of possible relevance to the present invention. No admission is necessarily intended, nor should be construed, that any of the preceding information constitutes prior art against the present invention.

### SUMMARY

An object of embodiments of the present invention is to provide a coiled tubing apparatus for oil and gas well operations.

In accordance with embodiments of the present invention, there is provided a coiled tubing apparatus for oil and gas well operations. The apparatus includes a platform. The platform includes or supports a plurality of roller bearings which are located on or overtop of an upper surface of the platform. The apparatus also includes a reel for holding coiled tubing. An outer circumferential portion of the reel is supported directly by the plurality of roller bearings to facilitate rotation of the reel on or overtop of the platform. The apparatus may further include one or more drives operatively coupled to a portion of the reel which is located away from a main rotational axis of the reel. The one or more drives are configured to cause rotation of the reel in order to spool or unspool the coiled tubing.

In accordance with embodiments of the present invention, there is provided a coiled tubing unit comprising the apparatus as described above. The coiled tubing unit can include a transportation trailer or vehicle, for example.

In accordance with embodiments of the present invention, there is provided a method for spooling or unspooling coiled tubing for oil and gas well operations. The method includes spooling or unspooling the coiled tubing onto a reel. An outer circumferential portion of the reel is supported directly by a plurality of roller bearings to facilitate rotation of the reel. The plurality of roller bearings are integrated into an upper surface of a platform. The method further includes controlling the spooling or unspooling of the coiled tubing using one or more drives operatively coupled to a portion of the reel which is located away from a main rotational axis of the reel. The one or more drives are configured to cause rotation of the reel.

### BRIEF DESCRIPTION OF THE FIGURES

Further features and advantages of the present invention will become apparent from the following detailed description, taken in combination with the appended drawings, in which:

FIGS. 1A and 1B illustrates a side profile view of a coiled tubing unit, according to an embodiment of the present invention.

FIG. 2 illustrates a cross sectional view of the coiled tubing unit of FIGS. 1A and 1B, according to an embodiment of the present invention.

FIG. 3 illustrates a portion of FIG. 2 showing a drive mechanism for the coiled tubing unit spool, according to an embodiment of the present invention.

FIG. 4 illustrates a cross-sectional view of the coiled tubing unit spool, according to an embodiment of the present invention.

FIG. 5 illustrates a method for operating a coiled tubing unit, according to an embodiment of the present invention.

It will be noted that throughout the appended drawings, like features are identified by like reference numerals.

### DETAILED DESCRIPTION

Embodiments of the present invention provide a coiled tubing apparatus for oil and gas well operations. A potential benefit in some embodiments is that the apparatus has a lighter (in weight) and/or higher capacity coiled tubing reel than the typical reels transported on trailers in the prior art. This can be due at least in part to orientation of the reel, as well as the means of supporting and driving the reel by engaging its outer rim, for example.

As used herein, the terms “spool” and “reel” are used substantially interchangeably. Both terms refer to a device upon which a flexible long item, such as a length of coiled tubing, can be wound, for example in one or multiple layers of helical windings. The terms may also be used as a verb to describe the act of winding or unwinding the item.

In accordance with embodiments of the present invention, the coiled tubing reel is supported on its platform (e.g. trailer) along its outside perimeter edge. This is in contrast to supporting the coiled tubing reel by mounting it on a central shaft, axle, or hub, aligned with the central rotational axis of the reel. In fact, such a central shaft, axle or hub can be and typically is completely omitted, meaning that the coiled tubing reel is fully supported on its outside perimeter edge. That is, the outer surface of the reel rests on a platform, and no axle or other support is necessarily connected to the rotational center of the reel. The coiled tubing reel support may include multiple bearings (e.g. cylindrical roller bearings), incorporated into the platform, upon which the reel rests to provide load-bearing support. In some embodiments, the bearings can be located at different points of a concave curve which matches with the convex curvature of the coiled tubing reel perimeter. The concave curve is typically shaped as an arcuate portion of a circle. The bearings may be powered or unpowered rollers.

As will be readily understood, the tubing can be helically wound around the reel, and later unwound. Multiple layers of tubing can be wound around the reel, one layer on top of another. Rotation of the reel can facilitate the winding process. Rotation of the reel in the opposite direction can facilitate the unwinding process.

In accordance with embodiments of the present invention, one or more drives are provided that can be operatively coupled to the coiled tubing reel to cause rotation of the reel. The drives can be offset from the rotational axis of the reel, so that they contact a part of the reel at or near the reel perimeter. For example, the drives can contact a driven part of the reel which is located near a circumferential perimeter of the reel. The drives can be hydraulic, electric, or other drives. The drives can be the exclusive means for rotating the reel. The drives can have a driven, rotating surface which contacts a curved surface of the reel to impart rotation to the reel. Brakes can be incorporated into the drives, the bearings, or both. Other types of brakes, for example brakes which engage the circumferential perimeter of the reel (i.e. the rim) can be provided.

In one embodiment, the drives can be configured to each rotate a pinion which engages with an annular gear. As will be readily understood, a pinion is a circular gear, while an annular gear is a generally ring-shaped structure with a toothed inner surface. The pinion is located within the ring of the annular gear, with the teeth of the pinion meshing with the toothed inner surface of the annular gear. Multiple such drives and pinions can be provided, either integrated together or separate. The drives can be located at one or both ends of the reel apparatus.

In accordance with embodiments of the present invention, there is provided a coiled tubing unit comprising the coiled tubing reel apparatus as described above and elsewhere herein. The coiled tubing unit can include various additional elements such as a levelwind, coiled tubing support equipment, controls, trailer or vehicle components coupled to the platform, etc.

In accordance with embodiments of the present invention, there is provided a method for spooling or unspooling coiled tubing from a reel. The method includes supporting a coiled tubing reel along its outside edge; operatively coupling one or more drives to the reel at a location offset from the reel's rotational axis; and rotating the reel using the one or more drives.

Embodiments of the present invention provide a coiled tubing reel apparatus for use on a coiled tubing unit. The reel apparatus is supported along the outer perimeter edge of the reel, for example using bearings, which may be in the form of roller bearings. Roller bearings may be metal, or wheels, or other bearing surfaces that rotate about an axis. These bearings may be mounted into a (e.g. curved or otherwise concave) cradle-like structure. The number and size of the bearings can be adapted depending on the weight and size of the reel. Such bearings can be provided in several locations to provide adequate support for the reel. The bearings can be provided at the front and back rear ends of the reel apparatus.

The bearings can optionally be provided at one or more middle sections of the reel apparatus.

By providing support at the edge of the reel rim, additional weight of equipment required to support and drive the reel at its rotational axis (e.g. a central driven axis support) can be avoided. This may allow for a configuration in which no bearings interface with the central axis of the reel. Instead, a basic, light, hollow reel can be used to hold the tubing. No central hub or axle is necessarily required to support the reel. However, it is contemplated that a central axis support or retention component could also be included. Such a component would be anchored to the platform or another part of the coiled tubing unit, and would engage with a central axis part of the reel, for example by insertion of an axle into a hollow central portion of the reel which is aligned with the reel's central axis.

In some embodiments, as mentioned above, at least one drive mechanism is operatively coupled, for example by a pivotable or retractable pinion, to the reel. By mounting the drive near the outside rim of the reel, precise control over the reel rotation can be obtained due to the gear reduction automatically provided by a small pinion driving a large gear. The gear may be an annular gear or another type of gear. This may obviate or mitigate the need for a transmission, gear box, or other additional component to interface between the drive and the reel. In some embodiments, this also allows for small, affordable, and easy to acquire drive mechanisms to be used. Multiple drives can be used to provide additional power and redundancy.

In some embodiments, the drives are mounted on a pivotable or retractable mount. Accordingly it can become relatively simple to pivot and/or retract the drives to engage or disengage the reel. When disengaged, the drives are moved clear of the reel area to facilitate removal of the reel from the support cradle, or to facilitate placement of the reel in the support cradle. When engaged, the drives apply mechanical power to rotate the reel. Also when engaged, the drives may hold the reel in place in the cradle. In one embodiment, the drives are mounted at the ends of respective arms which pivot or otherwise move to selectably engage or disengage the drives from the reel.

In one embodiment of the present invention, four support points are located in the cradle, each support point comprising a bearing such as a roller bearing. Four drives, for example located at or near the four support points, can also be provided. It is noted that more or fewer (e.g. three) support points, and more or fewer roller bearings, can also be provided in other embodiments.

Some embodiments provide for a coiled tubing unit comprising the reel apparatus as described elsewhere herein. The reel apparatus may be mounted onto a trailer, the back of a vehicle, or another mobile or stationary platform. Such a unit may require additional stability support when spooling or unspooling tubing. To address this, one or more outriggers may be attached to the platform, which can be deployed to contact ground and stabilize the platform. In some embodiments, such outriggers may swing away or telescope out from the chassis of the platform (e.g. trailer or vehicle). The outriggers can extend outward from the sides of the chassis. The reel may be mounted sideways (longitudinally) on the trailer or vehicle, such that the central rotational axis of the reel is aligned with (i.e. is parallel to) the main direction of travel of the trailer or vehicle.

In some embodiments, the reel is wider than about 12.5′. The width refers to the dimension in the axial direction of the reel.

In various embodiments, a spooling device (spooler or levelwind) used to direct the cable on-to and off-of the reel may be pivoted or swung into place once the reel is in the support cradle. A guard or guards to protect against uncontrolled tubing motion or other incidents may also be positioned in such a way after the reel is placed in the cradle.

A coiled tubing unit comprising a trailer or vehicle may require several axles and additional length to support the weight and length of the reel. Sections of this unit, located away from the tubing cradle, can be removed, flipped or folded up, reducing occupied space in a well site, yard, or other area that benefits from smaller equipment footprints. Sections of the unit (e.g. the trailer) can be pivotably mounted fore, aft, or both fore and aft of the tubing cradle. These sections can be pivoted upward when the unit is parked in order to conserve space. The sections can be locked in place to provide rigidity when required, for example using removable support rods passing through suitably sized and placed aperture structures mounted to the unit.

The reel can be simple in its design and construction. For example, the reel itself may consist essentially of a hollow tube and two rims extending radially outward from opposing ends of the tube. The diameter of the tube can be selected to provide sufficient structure support, without any requirement to fit an axle through the tube interior. In some embodiments the outer rim may be constructed from a bent I-beam. In some embodiments the driven portion of the reel, i.e. the portion of the reel that contacts and is moved by the drives, may include teeth or ridges extending radially inward (or outward) from the outer rim. That is, the driven portion may resemble a gear. The driven portion can be cut or burned from plate material.

In some embodiments, the reel's main rotational axis is aligned with the main direction of travel of the trailer/vehicle. In this case, the width of the reel, previously limited by reasonable and permittable trailer widths, is now limited by weight and length of the trailer/vehicle. Furthermore, apparatus weight and complexity is controlled by avoiding the required supports and structure for a center-driven reel, as well as by using smaller drives without additional transmissions or gear reductions. The result is a coiled tubing unit that may be relatively simple and capable of transporting more coiled tubing than was previously possible within reasonable transportation limits.

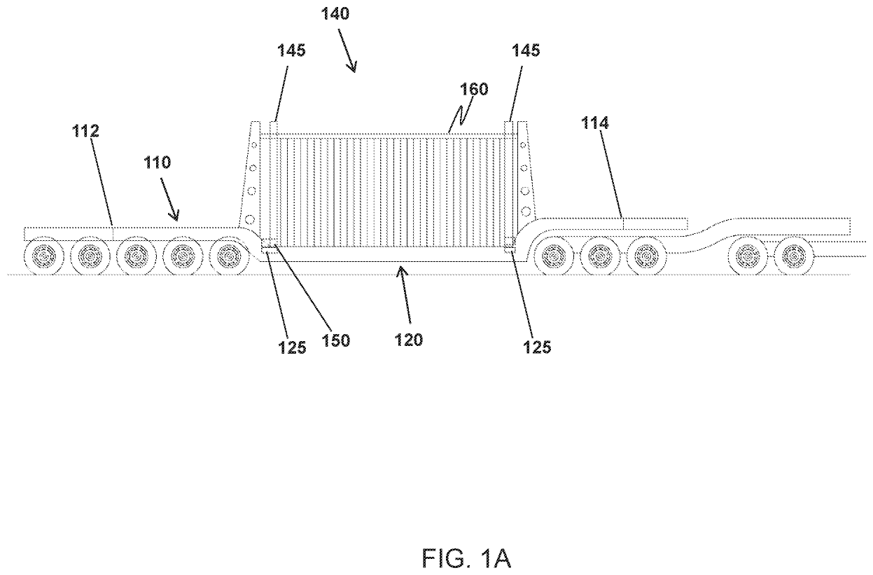

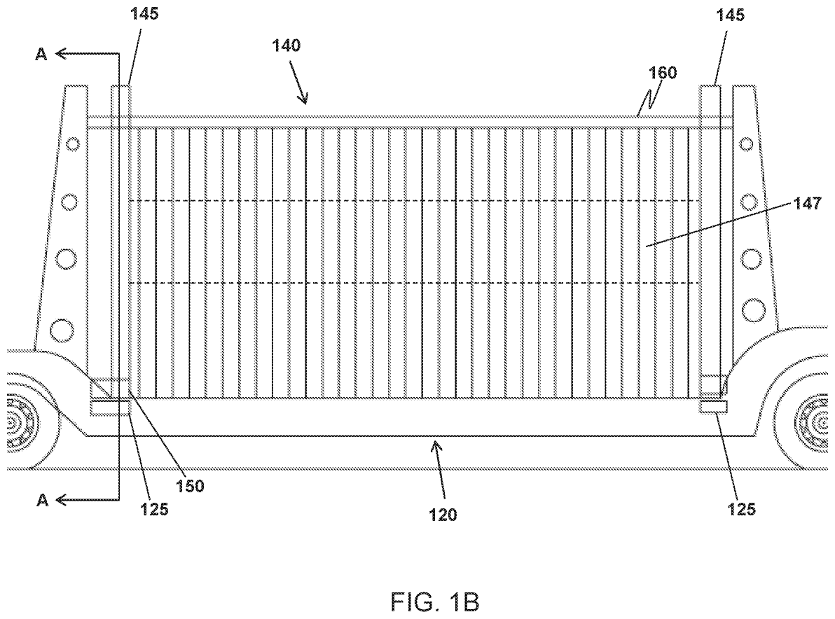

FIGS. 1A and 1B illustrate a side profile view of a coiled tubing unit, according to an embodiment of the present invention. FIG. 1B illustrates an enlarged portion of FIG. 1A. The unit includes a wheeled trailer 110 towable behind a vehicle. At a central location of the trailer is a cradle 120 for supporting a coiled tubing reel 140. The tubing reel 140 has a pair of circular rims 145 mounted at opposite ends of a central tube 147 (shown in FIG. 1B using dashed lines).

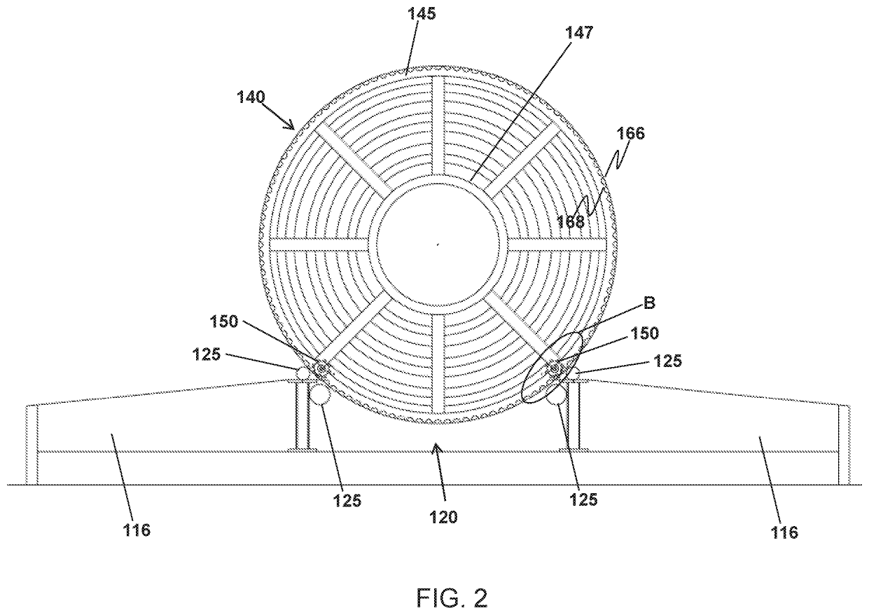

Roller bearings 125 are mounted to the cradle along an arcuate path which matches the outer diameter of the rims 145 of the tubing reel 140. The cradle may include a cavity which includes the arcuate path. If only two roller bearings per rim are present, the arcuate path may not be readily distinguishable. However, spatial allowance for the rims extending below the top edge of the roller bearings still implies the existence of a space for accommodating the rims, which is bounded by an arcuate path. In the illustrated embodiment, four roller bearings (two per rim) are provided, although only two are visible in each of FIGS. 1 and 2. The rims 145 rest on the roller bearings so that the reel is rotatably mounted on the coiled tubing unit by resting in the cradle 120. The roller bearings facilitate the rotation of the reel with limited resistance. A lowermost point of the reel is below the roller bearings, thus providing stability. The height of the roller bearings above this lowermost point of the reel can be selected to trade off stability vs. other structural constraints, such as allowable trailer width.

Also shown is a spooler 160 which is used to facilitate reeling or unreeling of the coiled tubing. The spooler is also referred to as a levelwind, i.e. the assembly that guides the tubing string onto and off of the reel drum, as would be readily understood by a worker skilled in the art. The spooler can provide a surface supporting the coiled tubing as it reels into or out of the reel 140, typically in a helically wound, multi-layer manner. The spooler 160 can be mounted on a pivot so that it can swing away when not required, or to facilitate loading or unloading of the reel 140 from the platform.

As also illustrated, the trailer 110 may have one or more hinges 112, 114 which allow outer portions of the trailer to fold inward. The hinges can be locked into place for transport using suitable locking bars, for example.

FIG. 2 illustrates a cross sectional view of the coiled tubing unit of FIGS. 1A and 1B, according to an embodiment of the present invention. The cross section is taken along the line A-A of FIG. 1B. In this view, outrigger 116, cradle 120, roller bearings 125, rim 145 of the reel 140, and drives 150 are visible.

As illustrated, the trailer 110 may have one or more outriggers 116, which are deployable from the side of the trailer to contact ground, thereby providing additional stability to the trailer. The outriggers may be stowable when not in use, and may be removable or mounted on hinges, for example.

As can be seen more clearly in FIG. 2, one or more mechanical drives 150, such as electric or hydraulic motors, are provided and operatively coupled to the reel to rotate same. At least one rim 145 of the tubing reel can include an inner surface 168 which extends around the circumference of the rim and faces radially inward toward the central rotation axis of the reel. This arrangement forms an annular gear which is integrated with the reel. The drives can include a toothed part (or other frictionally engaging surface) which engages (meshes) with the inner surface (annular gear). Rotation of the drives when engaged with this inner surface results in rotation of the inner surface through this engagement. Examples of this configuration will be shown in more detail in subsequent figures.

Alternatively, the drive can engage with an outer surface 166 of the at least one rim 145. However, in this case, the drive does not cooperate with the roller bearings in the same way to hold the reel in place. For example, as illustrated, the rim 145 is retained between the drives 150 and the roller bearings 125, thus retaining the reel 140.

Additionally or alternatively, at least one of the roller bearings 125 themselves can be powered rollers which are rotatably driven, and can sufficiently engage the reel (e.g. via friction or a toothed gear mechanism) to a degree that the roller bearings, when driven, will rotate the reel 140. It should be emphasized here that the rollers may be considered to be gears when they are provided with teeth or similar structures. However, for clarity and consistency, the term “roller” is still used herein.

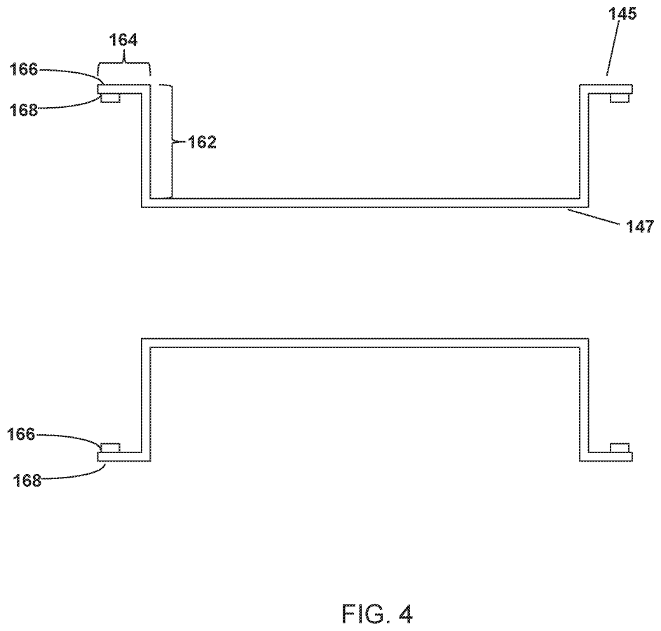

In some embodiments, if the roller bearings are powered and act as the primary means to rotate the real, the drives 150 can be replaced with unpowered rollers or gears which act in combination with the roller bearings to retain the reel in place. That is, an outer circumferential portion of the reel can include an axially extending, generally cylindrical member (see rim portion 168 in FIG. 4) having a curved outer surface (see outer surface 166 of FIG. 4) and a curved inner surface (see surface 168 of FIG. 4), and the reel can be rotated by a powered drive means which contacts either or both of the inner circumferential portion and the outer circumferential portion.

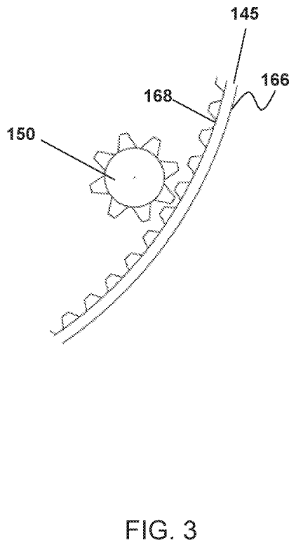

FIG. 3 illustrates a detail of a portion of FIG. 2. The detail corresponds to the contents of area B as marked in FIG. 2. In this view, a portion of the rim 145 of the reel 140 and part of one drive 150 are visible. The drive includes a gear as shown, which is coupled via a drive shaft to a motor such as an electric or hydraulic motor. The gear interfaces with a toothed surface on a radially inward-facing inner surface 168 located at an outer edge of the rim 145. The gears and meshing thereof are simplified for illustration and are not necessarily to scale or exactly as illustrated.

FIG. 4 illustrates a cross-section of the reel, taken through a plane which includes the main rotational axis of the reel, particularly showing an L-shaped configuration of the rim 145. This configuration facilitates provision of the radially inward-facing inner surface 168. Specifically, the rim 145 includes a first portion 162 which extends radially outward from the reel 140, and the rim 145 also includes a second portion 164 which extends axially outward from the radially outermost part of the first portion 162. The radially outer surface 166 of the second portion 164 can rest against the roller bearings 125. The radially inner surface 168 of the second portion 164 can engage with the drive 150. The radially inner surface 168 can include teeth, ridges, or another type of surface for engaging a corresponding toothed, ridged, or other surface of the drive 150. One or both rims of the reel can be configured and driven in this manner.

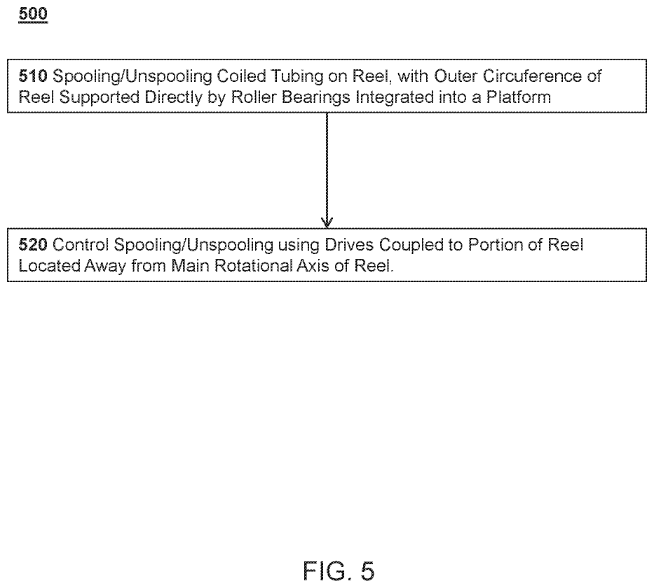

FIG. 5 illustrates a method 500 for spooling or unspooling coiled tubing for oil and gas well operations. The method includes spooling or unspooling 510 the coiled tubing onto a reel. An outer circumferential portion of the reel is supported directly by a plurality of roller bearings to facilitate rotation of the reel. The plurality of roller bearings are integrated into an upper surface of a platform. The method further includes controlling 520 the spooling or unspooling of the coiled tubing using one or more drives operatively coupled to a portion of the reel which is located away from a main rotational axis of the reel. The one or more drives are configured to cause rotation of the reel.

In some embodiments, the reel can be transported on a trailer, which is not necessarily adapted to allow for rotation of the reel. The reel can then be transferred (e.g. by tipping and rolling) onto a second platform, which is adapted to allow for rotation of the reel as described herein.

Although the present invention has been described with reference to specific features and embodiments thereof, it is evident that various modifications and combinations can be made thereto without departing from the invention. The specification and drawings are, accordingly, to be regarded simply as an illustration of the invention as defined by the appended claims, and are contemplated to cover any and all modifications, variations, combinations or equivalents that fall within the scope of the present invention.

What is claimed is:

1. A coiled tubing apparatus for oil and gas well operations, comprising:
a platform;
a plurality of roller bearings located on or above an upper surface of the platform; and
a reel for holding coiled tubing, an outer circumferential portion of the reel being supported directly by the plurality of roller bearings to facilitate rotation of the reel.

2. The apparatus of claim 1, further comprising one or more drives operatively coupled to a portion of the reel which is located away from a main rotational axis of the reel, the one or more drives configured to cause rotation of the reel.

3. The apparatus of claim 2, wherein the outer circumferential portion of the reel comprises an axially extending, generally cylindrical member having a curved outer surface and a curved inner surface, the outer surface contacting the plurality of roller bearings, the inner surface contacting the one or more drives.

4. The apparatus of claim 3, wherein the roller bearings and the drives cooperate to retain the reel rotatably in place.

5. The apparatus of claim 2, wherein the reel is driven exclusively by components, including the one or more drives, which engage a portion of the reel at a location away from said main rotational axis of the reel.

6. The apparatus of claim 2, wherein braking of the reel is performed exclusively via the one or more drives, or via one or more brakes coupled to the plurality of roller bearings, or via one or more brakes operatively coupled to the reel at a location away from the main rotational axis of the reel, or a combination thereof.

7. The apparatus of claim 2, wherein the roller bearings are powered rollers providing the one or more drives.

8. The apparatus of claim 1, wherein the platform is integrated into a vehicle or transportation trailer.

9. The apparatus of claim 8, wherein the reel is oriented to have a main rotational axis which is parallel to a main direction of travel of the vehicle or transportation trailer.

10. The apparatus of claim 1, wherein the reel has a width, in the axial direction, of greater than 12.5 feet.

11. The apparatus of claim 1, wherein the reel is fully supported by the plurality of roller bearings.

12. The apparatus of claim 1, wherein the plurality of roller bearings includes at least three roller bearings at three separate locations.

13. The apparatus of claim 10, wherein the platform comprises a cavity for accommodating the reel when the reel rests on the roller bearings.

14. The apparatus of claim 1, wherein braking of the reel is performed exclusively via one or more brakes coupled to the plurality of roller bearings, or via one or more brakes operatively coupled to the reel at a location away from the main rotational axis of the reel.

15. The apparatus of claim 1, wherein the roller bearings comprise a smooth, roughened or toothed outer surface.

16. The apparatus of claim 1, wherein the outer circumferential portion of the reel comprises an axially extending, generally cylindrical member having a curved outer surface and a curved inner surface, the outer surface contacting the plurality of roller bearings, the plurality of roller bearings being powered roller bearings configured to cause rotation of the reel, the inner surface contacting one or more additional gears or rollers, and the plurality of roller bearings and the additional gears or rollers are configured to retain the reel in place.

17. A coiled tubing unit comprising a coiled tubing apparatus for oil and gas well operations, the coiled tubing apparatus comprising:
a platform;
a plurality of roller bearings located on or above an upper surface of the platform; and
a reel for holding coiled tubing, an outer circumferential portion of the reel being supported directly by the plurality of roller bearings to facilitate rotation of the reel,
the coiled tubing unit further configured as a trailer or vehicle transporting the coiled tubing apparatus.

18. A method for spooling or unspooling coiled tubing for oil and gas well operations, the method comprising:
spooling or unspooling the coiled tubing onto a reel, an outer circumferential portion of the reel being supported directly by a plurality of roller bearings to facilitate rotation of the reel, the plurality of roller bearings integrated into an upper surface of a platform; and
controlling the spooling or unspooling of the coiled tubing using one or more drives operatively coupled to a portion of the reel which is located away from a main rotational axis of the reel, the one or more drives configured to cause rotation of the reel.
